(19) United States
(12) Patent Application Publication
(10) Pub. No.: US 2008/0274033 A1
(43) Pub. Date: Nov. 6, 2008

(54) Methods of generating hydrogen with nitrogen-containing hydrogen storage materials

(75) Inventors: Gregory P. Meisner, Ann Arbor, MI (US); Aimee G. Bailey, Hoosick Falls, NY (US); Michael P. Balogh, Novi, MI (US); Frederick E. Pinkerton, Shelby Township, MI (US); Martin S. Meyer, Southfield, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/743,826

(22) Filed: May 3, 2007

(51) Int. Cl. C01B 21/00; C01B 3/02

(52) U.S. Cl. 423/413; 423/648.1; 423/658.2

(57) ABSTRACT

Methods of generating hydrogen-containing streams having a minimal concentration of gaseous reactive nitrogen-containing compounds, e.g., ammonia, are provided. Hydrogen storage material systems are also provided that generate such hydrogen-containing streams. A first composition comprising a nitride, a second composition comprising a hydride, and a third composition having a cation selected from the group consisting of: alkali metals, alkaline earth metals, and mixtures thereof are combined together. The hydrogen-containing stream thus generated has a minimal concentration of gaseous reactive nitrogen-containing compounds.

### FIELD

The present disclosure relates to hydrogen storage compositions and more particularly to methods of generating hydrogen-containing streams with such hydrogen storage compositions.

### BACKGROUND

Hydrogen is desirable as a source of energy because it reacts cleanly with air producing water as a by-product. In order to enhance the utility of hydrogen as a fuel source, particularly for mobile applications, it is desirable to increase the available energy content per unit volume of storage. Presently, this is done by conventional means such as storage under high pressure, at thousands of pounds per square inch, cooling to a liquid state, or binding hydrogen into a solid such as a metal hydride. Pressurization and liquification require expensive processing and storage equipment.

Storing hydrogen in a solid material provides a relatively high volumetric hydrogen density and a compact storage medium. Hydrogen stored in a solid is desirable since it can be released or desorbed under appropriate temperature and pressure conditions, thereby providing a controllable source of hydrogen.

In addition to maximizing the hydrogen storage capacity or content released from the material, it is advantageous to minimize the weight of the material to improve the gravimetric capacity. Further, many current materials only absorb or desorb hydrogen at very high temperatures and pressures. Thus, it is desirable to find a hydrogen storage material that generates, i.e., releases, hydrogen at relatively low temperatures and pressures, and which have relatively high gravimetric hydrogen storage density.

The present disclosure provides an improved method of storing and releasing hydrogen from storage materials, as well as an improved hydrogen storage material composition.

### SUMMARY

In one aspect, the disclosure provides a method of releasing hydrogen. The method comprises combining a first composition comprising a nitride having one or more cations other than hydrogen, a second composition comprising a hydride having one or more cations other than hydrogen, and a third composition comprising a compound having a cation selected from the group consisting of: alkali metals, alkaline earth metals, and mixtures thereof. A hydrogen-containing stream is generated having a minimal concentration of gaseous reactive nitrogen-containing compounds.

In another aspect, a method is provided for generating a hydrogen-containing gas stream. The method comprises providing a hydrogen storage system formed from hydrogenated starting materials comprising a first composition comprising a nitride having one or more cations other than hydrogen, a second composition comprising a hydride having one or more cations other than hydrogen, and a third composition comprising a compound having a cation selected from the group consisting of: alkali metals, alkaline earth metals, and mixtures thereof. Hydrogen is generated from the hydrogen storage system via a dehydrogenation reaction, wherein the hydrogen-containing gas stream comprises the hydrogen so generated having a minimal concentration of reactive nitrogen-containing compounds.

In yet another aspect, the disclosure provides a hydrogen storage system comprising material having:

(a) a hydrogenated state capable of releasing hydrogen and formed from starting materials comprising a first composition comprising a nitride having one or more cations other than hydrogen; a second composition comprising a hydride having one or more cations other than hydrogen; and a third composition comprising a compound having an alkali metal cation, an alkaline earth metal cation, and mixtures thereof; and

(b) a dehydrogenated state formed after release of hydrogen from the hydrogenated state comprising: one or more byproduct compositions comprising: nitrogen and at least one of the one or more cations other than hydrogen derived from the nitride and derived from the hydride, and the alkali metal cation, the alkaline earth metal cation, or mixtures thereof, respectively, wherein the one or more byproduct compositions are in a solid and/or liquid state.

Further areas of applicability of the present disclosure will become apparent from the detailed description provided hereinafter. It should be understood that the detailed description and specific examples, while indicating the preferred aspect of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows the relative weight loss of hydrogen and ammonia from a combined hydrogen storage system comprising a ball-milled mixture of a stable intermediate compound (Li₃BN₂H₈) and LiH as temperature is increased to 350° C. and then held constant versus relative molar concentration of LiH; and

FIG. 2 shows a partial Li—B—N—H phase diagram.

### DETAILED DESCRIPTION

The following disclosure contains aspects that are merely exemplary in nature and are in no way intended to limit the disclosure, its application, or uses.

In one aspect, the present disclosure provides methods of storing and releasing hydrogen, while reducing, mitigating and/or suppressing formation of reactive nitrogen-containing compounds. Reactive nitrogen-containing compounds include any undesirable gaseous compounds that comprise a nitrogen atom, such as ammonia (NH₃) but exclude inert nitrogen-containing compounds such as nitrogen gas (N₂). Certain desirable hydrogen storage materials comprise nitrogen, inter alia, which can potentially form such reactive nitrogen-containing products. However, many applications that use hydrogen have a low tolerance for the presence of ammonia and other such reactive compounds. For example, in fuel cells that use hydrogen as a reactant, ammonia can poison fuel cell catalysts and further, due to its reactivity, can degrade other components in the fuel cell system. Thus, it is preferred to release hydrogen from various nitrogen-containing hydrogen storage materials while minimizing and/or eliminating the production of gaseous reactive nitrogen-containing products, hence improving the purity of hydrogen-containing gas streams generated by such hydrogen storage materials.

In various aspects, the hydrogen storage materials comprise a nitrogen atom. In certain aspects, preferred hydrogen storage material systems are formed from hydrogenated starting materials comprising three distinct compositions. As used herein, the terms “composition” and “material” are used interchangeably to refer broadly to a substance containing at least the preferred chemical compound, but which may also comprise additional substances or compounds, including impurities. Thus, in certain aspects, a hydrogen storage system is formed by combining a first composition, a second composition, and an additional third composition together. The first composition comprises a nitride having one or more cations other than hydrogen. The second composition comprises a hydride having one or more cations other than hydrogen, and the third composition comprises a compound having a cation selected from the group consisting of: alkali metals, alkaline earth metals, and mixtures thereof.

Nitride compounds, as used herein, include nitrogen-containing compounds having one or more cationic species, as described above, and hydrogen. The term “nitride” broadly includes compounds comprising amides (NH₂ group), imides or nitrenes (NH group), and azides (N₃ group).

In some aspects, the nitride is preferably represented by the general formula MIII^{f}(NH₈)_{g}^{-c}, where MIII represents a cationic species other than hydrogen, N represents nitrogen, H represents hydrogen, f represents an average valence state of MIII, c=(3−e),

$$g = \frac{f}{c} and ( e \times g )$$

represents the atomic ratio of hydrogen to cationic species (i.e., MIII) in the nitride compound.

Metal hydride compounds, as used herein, include those compounds having one or more cations other than hydrogen. In certain preferred aspects, the hydride comprises a complex metal hydride, which include two or more distinct cations other than hydrogen.

In certain aspects, the hydride is preferably represented by the general formulaMI^{a}(MIH_{b})ₐ, where MI represents a first cationic species other than hydrogen, MII represents a second cationic species other than hydrogen, a represents an average valence state of MI and

$$( \frac{a \times b}{1 + a} )$$

represents an atomic ratio of hydrogen to cationic species (i.e., MI and MII) in the hydride compound. In certain aspects, it is preferred that MI and MII are different species, forming the complex metal hydride. In some aspects, the metal hydride compound may have one or more cations that are selected from a single cationic species (ie., MI and MII are the same cationic species).

It should be understood that in the present disclosure MI, MII, and MIII of the nitride and hydride compounds, previously described, each represent a cationic species or mixture of cationic species other than hydrogen. Suitable examples of such cations include metal cations, non-metal cations such as boron, and non-metal cations which are organic such as CH₃. Species that form preferred nitrides, hydrides, and mixtures of cations in the type of compounds of the present disclosure are as follows. Preferred cationic species generally comprise: aluminum (Al), arsenic (As), boron (B), barium (Ba), beryllium (Be), calcium (Ca), cadmium (Cd), cerium (Ce), cesium (Cs), copper (Cu), europium (Eu), iron (Fe), gallium (Ga), gadolinium (Gd), germanium (Ge), hafnium (Hf), mercury (Hg), indium (In), potassium (K), lanthanum (La), lithium (Li), magnesium (Mg), manganese (Mn), sodium (Na), neodymium (Nd), nickel (Ni), lead (Pb), praseodymium (Pr), rubidium (Rb), antimony (Sb), scandium (Sc), selenium (Se), silicon (Si), samarium (Sm), tin (Sn), strontium (Sr), thorium (Th), titanium (Ti), thallium (TI), tungsten (W), yttrium (Y), ytterbium (Yb), zinc (Zn), and zirconium (Zr), and organic cations including (CH₃) methyl groups.

MI, MII, and MIII are independently selected in both the nitride and metal hydride compounds, and each may be different, or any two or more may be the same, cationic species. In certain preferred aspects according to the present disclosure, MI and MII are the same cationic species in both the nitride and the metal hydride; however, it is within the scope of the present disclosure to have distinct cationic species for MI of the nitride and the MII of the metal hydride. Further, MII may be the same as MI in the metal hydride, as previously discussed, creating a metal hydride with a single cationic species.

For nitride compounds, preferred cationic species comprise Al, B, Ca, Li, Na, K, Be, Sr and Mg. Particularly preferred nitride compounds according to the present disclosure comprise the following non-limiting examples, lithium amide (LiNH₂), sodium amide (NaNH₂), lithium nitride (Li₃N), borazane, also known as borane-ammonia complex, (BNH₆), lithium azide (LiN₃), magnesium amide (Mg(NH₂)₂), magnesium imide (MgNH), and mixtures thereof.

Particularly preferred cations for hydrides comprise cations selected from the group: Al, B, Ca, Li, Na, Mg, K, Be, Rb, Cs, Sr, and mixtures of these. Preferred metal hydrides according to the present disclosure comprise the following non-limiting examples, lithium hydride (LiH), lithium aluminum hydride (LiAlH₄), sodium borohydride (NaSH₄), lithium borohydride (LiBH₄), magnesium borohydride (Mg(BH₄)₂) and sodium aluminum hydride (NaAlH₄).

The third composition comprises a compound having a cation selected from the group consisting of: alkali metals, alkaline earth metals, and mixtures thereof. In certain aspects, the third composition consists essentially of an alkali or alkaline earth metal compound (e.g., lithium or calcium). In other aspects, a preferred compound is a hydride comprising a cation selected from the group consisting of alkali metals, alkaline earth metals, and mixtures thereof.

In some aspects, the compound of the third composition is preferably represented by the formula (MIIIHₕ)) where h represents an atomic ratio of hydrogen in the compound of the third composition and ranges from 0 to about 2. In certain aspects, a preferred cation MIII is selected from the group consisting of lithium (Li), sodium (Na), potassium (K), beryllium (Be), magnesium (Mg), calcium (Ca), and mixtures thereof. In some aspects, particularly preferred cations for MIII are Li, Na, and mixtures thereof. In certain aspects, the third composition preferably comprises a compound comprising Li.

In certain aspects, the third composition comprises a compound selected from the group consisting of: lithium hydride (LiH), sodium hydride (NaH), magnesium hydride (MgH₂), beryllium hydride (BeH₂), and mixtures thereof. In some aspects, the preferred third composition comprises magnesium hydride (MgH₂). In other aspects, the third composition preferably comprises lithium hydride (LiH).

Thus, in various aspects, the hydrogen storage system comprises a hydrogen storage material having a hydrogenated state and a dehydrogenated state. The hydrogenated state is formed by starting materials comprising a first composition comprising a nitride, a second composition comprising a hydride, and a third composition comprising an alkali metal cation, an alkaline earth metal cation, or both. It has been observed in some cases that such nitrogen-containing hydrogen storage systems undergo a dehydrogenation reaction to release hydrogen, however, under certain conditions, this reaction may also concurrently produce an undesirable concentration of reactive nitrogen-containing compounds such as ammonia. In accordance with various aspects of the present disclosure, such hydrogen storage material systems comprise a third composition. It has been discovered that the third composition serves to reduce a concentration and/or to prevent formation of ammonia and other similar reactive nitrogen-containing byproducts, during the dehydrogenation reaction, thus enabling a hydrogen-containing gas to be produced that has a minimal concentration of reactive nitrogen-containing compounds.

In certain aspects, it is preferred that the hydrogen-containing gas stream generated by the hydrogen storage system has a minimal concentration of gaseous reactive nitrogen-containing compounds, namely less than about 2% and optionally less than about 1% by weight of the nitrogen-containing reactive compounds in the stream. In other aspects, the amount of nitrogen-containing reactive compound is less than about 0.5% by weight. In certain aspects, a hydrogen-containing gas generated by a reaction releasing hydrogen from the hydrogen storage material is substantially free of reactive nitrogen-containing compounds. “Substantially free” is intended to mean that the compound is absent to the extent that it cannot be detected or that if the compound is present, it does not cause undue detrimental impact and/or prevent the overall use of the stream for its intended use. In some aspects, it is preferred that a concentration of nitrogen-containing reactive compound is less than about 5,000 parts per million (ppm), optionally less than about 1,000 ppm, optionally less than about 500 ppm, optionally less than about 100 ppm, and in some aspects, optionally less than about 50 ppm.

In some aspects, the nitride and hydride starting materials of the first and second compositions respectively, can react together to form a hydrogen storage composition material that is a stable intermediate (SI). In such aspects, the hydrogenated state of the hydrogen storage material preferably comprises at least a portion of formed SI compound. The formation of such a SI compound is dependent upon the individual chemical characteristics of the metal hydride and the nitride selected in the first and second compositions, and thus is most thermodynamically favored for certain preferred reactions, as will be described in more detail below. The SI hydrogen storage composition further undergoes a decomposition or dehydrogenation reaction where the stored hydrogen is released. The products of this decomposition reaction are hydrogen and one or more byproduct compounds comprising nitrogen, and the one or more cations other than hydrogen derived from both the nitride compound and the hydride compound, respectively. Such byproduct compounds can include ammonia or other gaseous reactive nitrogen-containing compounds.

In certain aspects, a stable intermediate hydrogen storage compound is formed in what is believed to be the following general reaction mechanism:

$$A {{MI}^{a} ( {MIIH}_{b} )}_{a} + {{BMIII}^{f} ( {NH}_{e} )}_{g}^{- c} \to {M}_{x}^{′} {M}_{y}^{″} {N}_{z} {H}_{d} \to {MI}_{A} {MII}_{( Axa )} {MIII}_{B} {N}_{( Bxg )} + D {H}_{2}$$

$$where D = \frac{d}{2} = \frac{1}{2} ( A \times a \times b \times B \times e \times g ) .$$

Although not wishing to be limited to any particular theory, a novel solid quaternary intermediate compound is known to occur where the metal hydride has one or more M′ cations selected as Li, and generally believed to occur where M′ is selected from the group consisting of: Li, Ca, Na, Mg, K, Be, and mixtures thereof, and where M″ comprises a cation compound comprising a Group 13 element from the IUPAC Periodic Table. Where the novel SI hydrogen storage composition is formed, such a composition is represented by the general formula M′ₓM″_{y}N_{z}H_{d}, where N is nitrogen and H is hydrogen. As can be observed in the mechanism above, such a compound undergoes an ideal decomposition reaction mechanism to form a dehydrogenated state where one or more decomposition byproducts, represented generally by the formula MI_{A}MII_{(Axa)}MIII_{b}N_{(Bxg)}, are formed in addition to a hydrogen product, represented by the general formula D H₂. As appreciated by one of skill in the art, such byproduct compositions may include other products such as gaseous reactive nitrogen-containing products. It should be noted that the M′ and M″ are formed from the MI, MII, and MIII cations present in the reactants, and may comprise one or more cations, including mixtures thereof. Preferably, the MI and MIII cations are the same, and form the M′. Further, in certain aspects, x is greater than about 50 and less than about 53; y is greater than about 5 and less than about 34; z is greater than about 16 and less than about 45; d=2D is greater than about 110 and less than about 177; and M′, M″, x, y, z, and d are selected so as to maintain electroneutrality of the compound.

Where the SI hydrogen storage composition (represented by the general formula M′ₓM″_{y}N_{z}H_{d}) is formed, it is preferred, in certain aspects, that an alkali metal hydride is reacted with an alkali nitride. One preferred example is where the lithium is the alkali metal cationic species. The formula unit (and corresponding atomic ratios) of the intermediate compound is best expressed by LiₓB_{y}N_{z}H_{d}, where preferred ranges for x are greater than about 50 and less than about 53; preferred ranges for y are greater than about 5 and less than about 34, preferred ranges for z are greater than about 16 and less than about 45, and preferred ranges for d are greater than about 110 and less than about 177. Further, x, y, z, and d are selected so as to maintain the electroneutrality of the hydrogen storage intermediate compound. The SI hydrogen storage compound may be represented by the simplified general formula Li_{q}BᵣNₛHₜ, where the atomic ratios may be expressed by the following relationships: q/r is about 3; s/r is about 2; and t/r is about 8. Thus, the average atomic ratio of one preferred SI can be expressed by the nominal general formula Li₃BN₂H₈. In certain aspects, the compounds that form the lithium SI compound are a lithium hydride reacted with a lithium nitride. Such lithium hydrides may include, for example, LiAlH₄, LiH, and LiBH₄. Lithium nitrides may include LiNH₂, Li₃N, BNH₆, and LiN₃.

In one aspect, the reactants for the reaction forming the LiₓB_{y}N_{z}H_{d} hydrogen storage composition are lithium amide compound and lithium borohydride compound. The preferred stoichiometry in the following reaction A LiBH₄+B LiNH₂→LiₓB_{y}N_{z}H_{d} is preferably a stoichiometric ratio of nitride to metal hydride (A:B) from between about 0.5 (e.g., 1:2) to about 3 (e.g., 3:1). Particularly preferred stoichiometric ratios of A:B are where A is about 1 and B is between about 2 to about 2.25, which corresponds to an x of about 50, a y of about 15 to about 17, a z of about 33 to about 35, and an d of about 130 to about 134. For this reaction, the temperature of formation at ambient pressure is from about 85° C. to about 95° C.

Such nitrogen-containing hydrogen storage materials are disclosed in U.S. patent application Ser. No. 10/789,899 filed on Feb. 27, 2004 to Pinkerton, et al., the disclosure of which is incorporated by reference in its entirety.

The SI hydrogen storage material is preferably in a solid phase form, and most preferably in a single solid phase form. The SI hydrogen storage composition preferably comprises hydrogen, nitrogen, and at least one of the one or more cations other than hydrogen derived from the nitride and derived from the hydride, respectively. Thus, in various aspects, the disclosure provides methods of releasing hydrogen from hydrogen storage materials comprising a quaternary SI hydrogen storage composition. The reaction between the nitride and hydride compounds, described above, forms the stable quaternary intermediate (the novel hydrogen storage compound). Hydrogen may be stably stored at ambient conditions in the formed SI compound. When the release of hydrogen is desired, heat and/or pressure are applied to facilitate a dehydrogenation reaction, where hydrogen gas is released from the quaternary SI hydrogen storage compound and one or more decomposition byproducts are formed.

In another aspect, the present disclosure provides a method of releasing and generating hydrogen by combining starting materials including the first, second, and third compositions. In some aspects, the starting materials appear to react to produce hydrogen directly, rather than to form a stable intermediate. As described above, whether the SI forms depends on the thermodynamics of each reaction. The SI appears not to form in some reactions, either due to the instability of any intermediate that may form or because the reaction does not appear to produce any intermediate; rather, the reaction in those cases directly proceeds to the final reaction products (i.e., hydrogen and the one or more substantially dehydrogenated byproduct compounds). As referred to herein, the word “substantially,” when applied to a characteristic or property of a composition or method of this disclosure, indicates that there may be variation in the characteristic without having a significant effect on the chemical or physical attributes of the composition or method.

While not limiting as to the present disclosure, it is believed that the majority of hydrogen generated from the storage material system is produced from a reaction between the nitride and hydride. As described above, such a reaction is also believed to generate gaseous, reactive, nitrogen-containing compounds under certain conditions. It is believed that any such ammonia or other nitrogen-containing products formed by the decomposition reaction are then reacted with the third composition to form solid and/or liquid phase byproducts comprising nitrogen, thus retaining the nitrogen-containing byproduct(s) in the hydrogen storage material system. It is believed that such a byproduct typically takes the form of an amide, although such an amide may further release hydrogen to form an imide byproduct and/or mixtures of imides and/or amides. Such a byproduct will be referred to as an “amide”, but it should be understood that it may include imides or mixtures of amides and imides. As appreciated by one of skill in the art, the intimate mixture of reactants in the hydrogen storage system may facilitate the formation of a variety of byproduct compounds and phases that can be dispersed throughout the hydrogen storage material system.

Thus, according to one aspect, the general reaction for releasing hydrogen via reaction of a first nitride composition, a second hydride composition and a third composition is believed to proceed according to the following mechanisms, which can occur substantially at the same time after initiation of the first reaction:

$$\begin{matrix}A {{MI}^{a} ( {MIIH}_{b} )}_{a} + B {{MIII}^{f} ( {NH}_{e} )}_{g}^{- c} + E {MIIII}^{h} {H}_{h} \to {MI}_{A} {MII}_{( Axa )} {MIII}_{B} {N}_{( Bxg ) - x} + E {MIIII}^{h} {H}_{h} + x {NH}_{3} + ( D - {}^{3} {/}_{2} x ) {H}_{2} \\ where c = ( 3 - e ) ; g = \frac{f}{c} ; and D = \frac{1}{2} ( A \times a \times b + B \times e \times g ) . & ( 1 ) \\ E {MIIII}^{h} {H}_{h} + x {NH}_{3} \to {}^{x} {/}_{m} {{MIIII}^{h} ( {NH}_{k} )}_{m}^{- j} + ( E - {}_{}^{x}{/}{}_{m}^{} ) {MIIII}^{h} {H}_{h} + G {H}_{2} \\ where j = ( 3 - k ) ; m = \frac{h}{j} ; G = ( 3 - k ) x ; and E \geq \frac{x}{m} . & ( 2 )\end{matrix}$$

The overall reaction is:

$$A {{MI}^{a} ( {MIIH}_{b} )}_{a} + B {{MIII}^{f} ( {NH}_{e} )}_{g}^{- c} + E {MIIII}^{h} {H}_{h} \to {MI}_{A} {MII}_{( Axa )} {MIII}_{B} {N}_{( Bxg ) - x} + {}^{x} {/}_{m} {{MIIII}^{h} ( {NH}_{k} )}_{m}^{- j} + ( E - {}_{}^{x}{/}{}_{m}^{} ) {MIIII}^{h} {H}_{h} + ( D + G - {}^{3} {/}_{2} x ) {H}_{2} . \qquad ( 3 )$$

The total amount of hydrogen is expressed by

H₂=z=D− 3/2x+G=D− 3/2x+(3−k)x=D+( 3/2−k)x

where a, b, c, e, f, g, h, x, A, j, D, E, G, m, and B, are selected so as to maintain electroneutrality. It should be noted that the byproduct compound MI_{A}MII_{(Axa)}MIII_{B}N_{(Bxg)-x} may thermodynamically favor decomposing into further smaller and/or distinct byproduct compounds. These further byproducts are formed of the same general constituents as the primary byproduct, but they have different valence states, atomic ratios, and/or stoichiometry, depending on the cationic species involved, as recognized by one of skill in the art. Such additional distinct byproduct compounds may include metal hydrides, which may slightly detract from the total amount of hydrogen generated designed as (D− 3/2x) H₂. Further, as mentioned above, it is believed that one of the byproducts formed is an amide and optionally an imide, or mixtures thereof. It is believed that this byproduct occurs by reaction of ammonia (formed during the reaction between the nitride and hydride) with the third composition (e.g., a second hydride).

This amide byproduct is optionally a solid and/or a liquid phase and is dispersed throughout the other byproduct phases formed in the reaction. Thus, in certain aspects, the dehydrogenated hydrogen storage system is a multi-phase material that comprises at least two distinct phases of byproducts. The phases are intimately mixed in a single storage system, as discussed in more detail below. The formation of the amide and/or imide product within the hydrogen storage system creates a byproduct containing nitrogen, thus eliminating formation of ammonia, but also generating a byproduct compound interspersed throughout the hydrogen storage material that is generally recognized for its capability to reversibly store hydrogen. Hence, by suppressing and/or reducing ammonia release, the amount of released hydrogen is increased compared to the amount of hydrogen released in the absence of the third compound. This reduction of ammonia release also slows the rate of irreversible degradation of the storage material with each hydriding cycle by retaining the nitrogen in the hydrogen storage materials rather than allowing it to escape in gaseous byproducts.

Thus, in certain preferred aspects, the present disclosure provides two distinct physical states, one where hydrogen is “stored” and another subsequent to hydrogen release. Where the starting reactants react without forming an SI, the hydrogenated storage state corresponds to the reactants (i.e., because a stable hydrogenated intermediate is not formed), and the byproduct compound(s) correspond to the dehydrogenated state. Where the starting reactants form an SI, the hydrogenated state refers to the system comprising such an SI as well as the third composition, inter alia. The byproduct compounds likewise correspond to the dehydrogenated state.

Examples of reactions which are believed to form a SI hydrogen storage composition comprise:

(1) LiBH₄+2LiNH₂+c LiH→Li₃BN₂H₈+c LiH→Li₃BN₍₂₋ₓ₎+x LiNH₂+(c−x) LiH+zH₂. It should be noted that in circumstances where nitrogen-containing reactive compounds, such as ammonia, are formed, this detracts from the amount of hydrogen actually generated, which accordingly can significantly reduce the actual amount of hydrogen generated. In this reaction, a stable intermediate hydrogen storage compound, Li₃BN₂H₈, undergoes a dehydrogenation reaction, producing x moles of ammonia (NH₃), where z=(4−x/2) and c ranges from zero to about 5 moles. The third composition in the present aspect is shown as LiH; however, other exemplary third compositions can include NaH, MgH₂, BeH₂, and the like. Exemplary reactions are provided below with lithium hydride, sodium hydride, and magnesium hydride.

Hence, a similar hydrogen storage material system is

(2) LiBH₄+2LiNH₂+c NaH→Li₃BN₂H₈+c NaH→Li₃BN₍₂₋ₓ₎+x NaNH₂+(c−x) NaH+zH₂, where z=(4−x/2), where Li₃BN₂H_{B} undergoes a dehydrogenation reaction, producing x moles of NH₃, and where c ranges from zero to about 5 moles. Similarly, another hydrogen storage material system is
(3) LiBH₄+2LiNH₂+c MgH₂→Li₃BN₂H₈+c MgH₂→Li₃BN₍₂₋ₓ₎+x/2 Mg(NH₂)₂+(c−x/2) MgH₂+zH₂, where z=(4−x/2), where Li₃BN₂H₈ that undergoes a dehydrogenation reaction, producing x moles of NH₃ ammonia, and where c ranges from zero to about 5 moles.

(4) LiAlH₄+2LiNH₂+c LiH→Li₃AlN₍₂₋ₓ₎+x LiNH₂+(c−x) LiH+zH₂, producing x moles of ammonia (NH₃), where, z=(4-x/2) and c ranges from zero to about 5 moles.

Another similar reaction is (5) LiAlH₄+2 LiNH₂+c NaH→Li₃AlN₍₂₋ₓ₎+x NaNH₂+(c−x) NaH+zH₂, where z=(4−x/2) and c ranges from about zero up to about 5 moles.

Likewise, a similar hydrogen storage material system is (6) LiAlH₄+2 LiNH₂+c MgH₂→Li₃AlN₍₂₋ₓ₎+x/2 Mg(NH₂)₂+(c−x/2) MgH₂+zH₂, where, z=(4−x/2), where c ranges from zero to about 5 moles.

Other non-limiting examples of alternate preferred aspects where hydrogen generation occurs but where a stable SI hydrogen storage composition although possible, is less favored to form prior to the hydrogen release/hydride generating reaction (based on predicted thermodynamics), include the following exemplary reactions:

(7) NaBH₄+2 NaNH₂+c MIII^{h}Hₕ→Na₃BN₍₂₋ₓ₎+x/h MIII^{h}(NH₂)ₕ+(c−x/h) MIII^{h}Hₕ+z H₂, where a predicted intermediate compound is Na₃BN₂H₈, and where z=(4−x/2), where c ranges from zero to about 5 moles.

(8) Mg(BH₄)₂+5Mg(NH₂)₂+(c) MIII^{h}Hₕ→2 Mg₃BN₍₃₋ₓ₎₊^{(4+2x)}/h MIII^{h}(NH₂)ₕ+(c−^{(4+2x)}/h) MIII^{h}Hₕ+z H₂ which forms a by-product of the cationic species: magnesium boroazide Mg₃BN₃, and where z=12−x, and c ranges from zero to about 5 moles.

(9) Mg(BH₄)₂+6Mg(NH₂)₂+c MIII^{h}Hₕ→2 Mg₃BN₍₃₋ₓ₎+MgH₂+^{(12+4x)}_{/h MIII}^{h}(NH)_{h/2}+(c−^{(12+4x)}/h) MIII^{h}Hₕ+z H₂ which forms two by-products of the cationic species, magnesium boroazide Mg₃BN₃ and magnesium hydride MgH₂, where, z=18+x and c ranges from zero to about 5 moles.

(10) Mg(BH₄)₂+2Mg(NH₂)₂+c MIII^{h}Hₕ→Mg₃B₂N₍₄₋ₓ₎+(c−^{2x}/h) MIII^{h}Hₕ++^{2x}/h MIII^{h}(NH)_{h/2}+z H₂ which generates a theoretical 9.6 wt % hydrogen of the starting reactants, where z=8+x/2 and c ranges from zero to about 5 moles.

Each of these reaction mechanisms preferably includes a third composition, represented by MIII^{h}Hₕ, where h can range from 0 to 2 and MIII is a cation selected from the group consisting of alkali metals, alkaline earth metals, or mixtures thereof, which is present in a molar amount of “c” that reacts with “x” moles of ammonia produced via the hydrogen generation to create an amide and/or imide product as described above. In certain aspects, the hydride is selected form the group consisting of LiH, NaH, MgH₂, BeH₂, and mixtures thereof.

Examples of exemplary preferred reactions according to the above mechanism having a third reactant composition include:

(11) LiBH₄+2LiNH₂+c Li→Li₃BN₂H₈+c Li→Li₃BN₍₂₋ₓ₎+x LiNH₂+(c−x) Li+zH₂, where z=4−x, and, where Li₃BN₂H₈ undergoes a dehydrogenation reaction, producing x moles of NH₃, and where c ranges from zero to about 5 moles.

Likewise, a similar hydrogen storage material system is

(12) LiBH₄+2LiNH₂+c Na→Li₃BN₂H₈+c Na→Li₃BN₍₂₋ₓ₎+x NaNH₂+(c−x) Na+zH₂, where, z=4−x, and where Li₃BN₂H₈ undergoes a dehydrogenation reaction, producing x moles of NH₃, and where c ranges from zero to about 5 moles. Other exemplary reactions according to the present disclosure occur according to the mechanism:

(13) NaH+c LiH+2LiNH₂→NaN₂₋ₓH₂+LiN₂₋ₓH₂₊(c−x)LiH+4H₂ Such hydrogen storage materials (not including the third composition for nitrogen-containing compound suppression) are disclosed in U.S. Pat. No. 6,967,012 issued on Nov. 22, 2005 to Meisner, et al., which is herein incorporated by reference in its entirety. For example, U.S. Pat. No. 6,697,012 discloses storing and releasing hydrogen according to the general mechanism:

M(NH)ₓ+wH₂⇄MI(NH₂)ₓ+MIIH_{z}

where x and z are selected to maintain charge neutrality; MI, MII and M each represent one or more cations, as described above for the nitride and hydride; and 2w=x+z. M(NH)ₓ is an imide, MI(NH₂)ₓ is an amide, and MIIH_{z} is a hydride.

While not listed herein, a variety of other combinations of first, second, and third compositions and permutations of hydrogen storage and release reactions are contemplated by the present disclosure.

The second composition hydride and the third composition compound may be hydrides that are the same composition, so long as a stoichiometric excess is provided to react with any ammonia produced. In previous hydrogen storage material systems, the amount of hydride present as a reactant was optimized to approach only the amount necessary to react with the nitride composition to release hydrogen. An excess amount of such a hydride was viewed to be undesirable, as it could not react with the nitride and was believed to act as a diluent, i.e., dead weight, that reduced the efficiency of the system. In accordance with the principles of the disclosure, an excess amount of such a compound is found to be beneficial to reduce and/or suppress production of ammonia or other reactive nitrogen-containing compounds.

In certain aspects, the hydrogenated starting materials are combined such that the first composition (i.e., the nitride) is present in a molar amount of “a”, wherein 1≦a≦4, the second composition (i.e., the hydride) is present in a molar amount of “b”, wherein 0.5≦b≦3, and the third composition is present in a molar amount of “c”, wherein 0<c≦5. In certain aspects, a=2, b=1, and 0<c≦5, more preferably 0<c≦3.

Preferred conditions for reaction of the first composition comprising the nitride compound with the second composition comprising the metal hydride compound vary with respect to preferred temperature and pressure conditions for each independent reaction. It is preferred that the reaction is carried out as a condensed state or solid state reaction, in a non-oxidizing atmosphere, essentially in the absence of oxygen, preferably in a hydrogen atmosphere, or other gases such as nitrogen or argon. As described above, in some aspects, the combining of the starting material compositions and the dehydrogenation occur concurrently. In other aspects, the combining may be carried out independently of the hydrogen generating reaction, for example, where a stable intermediate hydrogen storage composition is formed and hydrogen is subsequently released. In such an aspect, the conditions for forming the stable intermediate may be different from those where hydrogen is released, as appreciated by one of skill in the art. In various aspects, the suppression, reduction and/or minimization of the formation of gaseous nitrogen-containing compounds during the dehydrogenation reaction is further achieved (in addition to the inclusion of a third composition) by conducting the hydrogen release/decomposition reaction in an inert atmosphere that comprises nitrogen gas, argon gas, helium gas, or mixtures thereof. In certain aspects, the reaction is conducted in an atmosphere that consists essentially of nitrogen gas. Such methods of controlling the atmosphere to suppress and/or reduce gaseous nitrogen-containing compounds in nitrogen-containing hydrogen storage materials are disclosed in U.S. patent application Ser. No. 10/860,628 filed on Jun. 3, 2004 to Meyer, et al., which is herein incorporated by reference in its entirety.

Further, in certain aspects, it is desirable that the hydrogenated starting materials, namely the first, second, and third compositions are respectively reduced in particle size from their starting size. In the case of the nitride, an average particle diameter size of less than about 3 μm is preferred, and for the metal hydride and the third composition compound an average particle diameter size of less than 25 μm (microns) and most preferably to less than 15 μm is desirable. The reduction of particle size may occur prior to conducting the reaction or concurrently to conducting the reaction between the compounds. In certain preferred aspects, the hydrogen release, dehydrogenation reaction is carried out at ambient pressure and at a temperature of about 85° C. or higher. However, as recognized by one of skill in the art, such temperatures and pressures are highly dependent on the reaction kinetics for each individual reaction.

The various aspects of the disclosure release hydrogen according to the specific characteristics of the combined materials and their respective isotherms. It should be noted that the system behaves in a manner whereby at a pre-selected temperature there is a threshold pressure above which hydrogen is absorbed and below which hydrogen is desorbed. Thus, for the dehydrogenation/decomposition reaction(s), the pressure is preferably below such a threshold pressure for a pre-selected temperature.

With regard to aspects where a hydrogen storage material system comprises a SI hydrogen storage composition, the storage system is stable and hydrogenated at ambient conditions. When release of the hydrogen is desired, the composition is heated to a temperature of about 150 to about 200° C., for example about 170° C. at ambient pressure. The melting point of the SI hydrogen storage composition is about 210° C. at ambient pressure. Hydrogen release has been observed to occur much more rapidly when the SI hydrogen storage composition is in a liquid state, versus a solid or partially solid state, and thus according to the present disclosure, it is preferred that the compound is heated to above the melting point of the composition to rapidly release the hydrogen gas.

In certain aspects, where the starting materials comprise an amide and a hydride, these systems generally release hydrogen at elevated temperatures, for example about 380° C., where pressure is less then 10 atmospheres (1000 kPa). At lower temperatures the pressure to release is correspondingly lower. For example, to desorb at 125° C. the pressure is preferably less than 10 kPa. It is possible to desorb at up to 1000 kPa at temperatures higher that about 280° C. By way of further example, at room temperature, the pressure for hydrogen release is near zero, vacuum.

Milling (e.g., ball milling) of LiBH₄ and LiNH₂ (for example, in a 1:2 molar ratio) induces a transformation to the stable hydrogen storage intermediate compound, which is a quaternary hydride phase Li₃BN₂H₈. A hydrogen storage material system comprising such a compound is desirable, as it is capable of stably storing hydrogen at relatively low temperatures and pressures (such as ambient conditions) for long durations of time.

### EXAMPLE 1

In a first experiment, starting material powders are mixed in an equivalent molar proportion of 1 LiBH₄:2 LiNH₂:n LiH, such that 1 mole of LiBH₄ is combined with 2 moles of LiNH₂ and a varying number of moles of LiH (as the third composition). These starting material compounds react according to the above described chemical reaction mechanism to release hydrogen. The LiBH₄ is commercially available from Lancaster Synthesis, Inc. of Windham, N.H. (and is specified to be ≧95% purity) and the LiNH₂ is commercially available from Aldrich Chemical Co. of St. Louis, Mo. (also specified to be ≧95% purity).

The LiH is commercially available from Alfa-Aesar of Ward Hill, Mass. The typical purity is 98% on a metal basis, and it has a 99.4% overall purity.

The starting material powders are sealed into a hardened steel ball mill jar while inside an argon (Ar) inert atmosphere glove box. One large and two small steel balls are placed in the jar with the powder. The material is then high-energy ball milled for at least five hours using a SPEX 8000 mixer-mill. The resulting powder appears to comprise Li₃BN₂H₈ and nLiH. The resulting powder mixture was then heated at 20° per minute from ambient room temperature to a maximum temperature of about 350° C. and the amount of hydrogen produced and ammonia produced is estimated by a thermogravimetric analyzer (TGA) analysis.

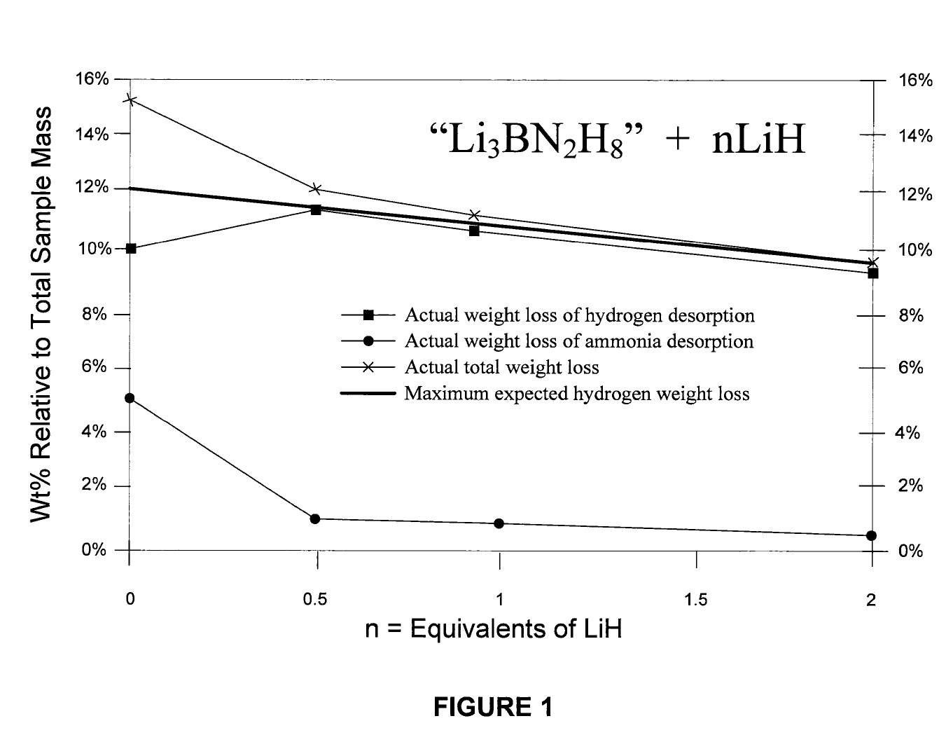

FIG. 1 shows the results of the Example 1, where the amount of ammonia produced in the system decreases as the number of moles of lithium hydride increases from 0 to about 2. For circumstances where the dehydrogenation reaction of a hydrogenated storage material produces ammonia, it is thus advantageous to include a third composition that reacts with the ammonia to reduce and/or eliminate an amount of ammonia in the hydrogen-containing stream generated. The amount of such a third composition can vary depending on the propensity of the individual hydrogen storage material to release ammonia, the desired conditions for releasing hydrogen, as well as other circumstances recognized by those of skill in the art. However, generally, the presence of such a third composition involves a trade-off between excess weight in the hydrogen storage system and the ability to react with the requisite amount of ammonia to reduce it to a target concentration while optimizing the amount of hydrogen released. As such, while the molar amount of the third composition may vary, in certain aspects, it is less than about 5 moles, optionally less than about 3 moles, and in some aspects less than 2 moles, per mole of ammonia (NH₃) released.

A first series of experiments are conducted according to a method of making a hydrogen storage compound according to the teachings of the present disclosure, where “a” moles of LiBH₄ are combined with “b” moles of LiNH₂ and “c” moles of LiH as the third composition. These experiments demonstrate that the presence of the third composition (LiH) has the effect of reducing reactive nitrogen-containing gaseous compounds like ammonia. These starting material compounds and the experiments are conducted in the same manner as described above in the context of Example 1. After ball-milling, the resulting powder appears to comprise Li₃BN₂H₈ and LiH. The resulting powder was then heated at 5° per minute from ambient room temperature to a maximum temperature of about 450° C. and the amount of hydrogen produced and ammonia produced is estimated by a TGA analysis combined with a corresponding residual gas analysis (RGA) obtained with a mass spectrometer monitoring the exhaust gas from the TGA.

TABLE 1

| | | | Hydrogen | Ammonia |
|---|---|---|---|---|
| “a” moles | “b” moles | “c” moles of | Produced | Produced |
| of LiBH₄. | of LiNH₂. | LiH. | (weight %) | (weight %). |
| 1 | 3 | 0 | 9.5 | 7.5 |
| 1 | 3 | 1 | 9.0 | 1.4 |
| 1 | 3 | 2 | 9.5 | 1.4 |
| 1 | 2 | 0 | 10.3 | 5.0 |
| 1 | 2 | 0.5 | 11.2 | 1.0 |
| 1 | 2 | 1 | 10.4 | 0.8 |
| 1 | 2 | 2 | 9.3 | 0.3 |
| 1 | 1.5 | 0 | 5.0–6.6 | 5.5–7.0 |
| 1 | 1.5 | 1 | 9.1 | 1.1 |

As can be observed from the data in Table 1, the inclusion of the third composition, namely the LiH, significantly reduces the ammonia production, while substantially maintaining and/or increasing hydrogen production in most cases. In accordance with the principles of the disclosure, a hydrogen-containing stream having a desirable low concentration of nitrogen-containing reactive compounds can be generated from hydrogen storage materials comprising nitrogen. It is believed that the lithium hydride reacts with the ammonia formed from a reaction between the first nitride composition and the second hydride composition, and forms a new non-gaseous phase which is dispersed throughout the other solid and/or liquid phases forming the hydrogen storage materials of the hydrogen storage system. It is believed that the new phase formed by the reaction of ammonia and lithium hydride is a liquid α-phase, likely formed of an amide and/or imide compounds. As such, the hydrogen storage material system is comprised of multiple phases. In some aspects, at least one phase is a solid phase. In other aspects, at least one phase is a liquid phase. In some aspects, the hydrogen storage system comprises a mixture of solid and liquid phases in the multi-phase structure.

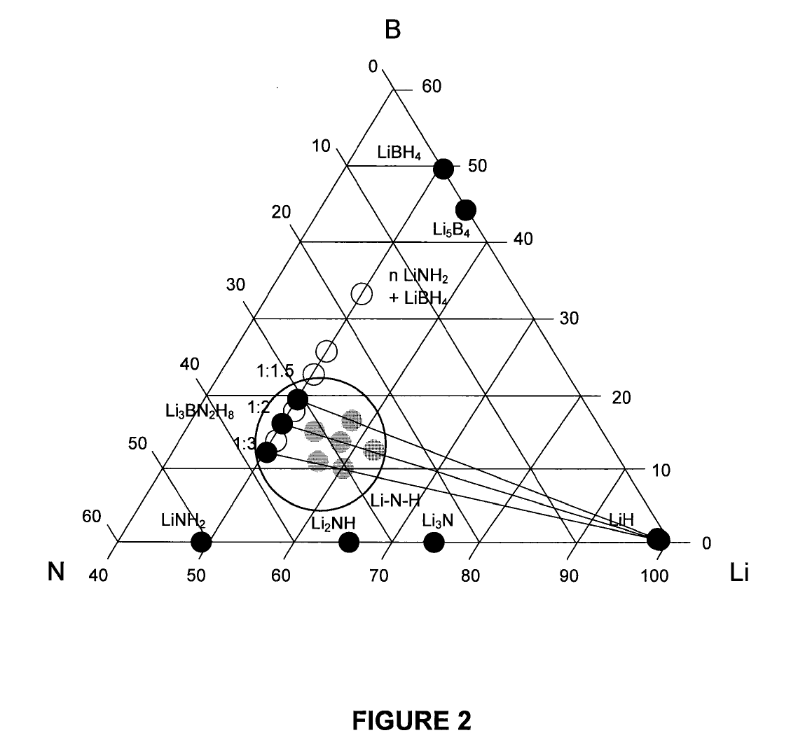

In FIG. 2, a portion of a Li—B—N—H phase diagrams shows possible compositions for certain preferred aspects where the cations are selected to be lithium and/or boron for the nitride and hydride, respectively. Such compositions include those studied in Table 1 above. The line designated “A” connects the Li₃BN₂H₈ to LiH compositions. The line includes various molar ratio mixtures, including a 1:2 molar ratio mixture of the Li₃BN₂H₈ to LiH, respectively. The other compositions are multiphase materials where Li₃BN₂H₈ is the major phase. Various mixtures of lithium amide and lithium borohydride appear to react to form a multiphase material containing Li₃BN₂H₈ compound, as well as other phases. As described previously above, a 1:2 molar ratio of lithium borohydride to lithium amide optimally forms the Li₃BN₂H₈ compound. In one preferred aspect, where the cations of the first and second compositions are selected to be lithium and boron, the optimal atomic ratio of lithium to boron to nitrogen is 3:1:2, respectively.

Other mixtures of lithium borohydride and lithium amide have been observed to release a greater amount of ammonia when they release hydrogen as compared to the stoichiometric mixture that leads to the forming of the composition of Li₃BN₂H₈. The effect of lithium hydride addition to these hydrogen storage systems was also found to be beneficial in reducing the amount of ammonia released in these mixtures as well, as summarized in Table 1.

Although the reversibility of some of the reactions detailed in the present disclosure do not appear to presently occur at sufficient rates at suitable temperature and pressure conditions desirable for a commercial aspect, incorporating a catalyst is one known method to both reduce the hydrogen release temperature and facilitate reabsorption of hydrogen in other prior art hydrogen storage materials. Thus, the present disclosure contemplates employing such a catalyst, as known to one of skill in the art, to facilitate reversibility at desirable conditions and rates. Catalysts that may be useful with the present disclosure, include, for example, the following non-limiting list: Fe, Ni, Co, Pt, Pd, Sr, and compounds and mixtures thereof. Further, other additional developments in the art that provide methods and/or compositions that may permit sufficient reversibility at commercially viable temperature and pressure conditions, would be useful for the various aspects of the disclosure are contemplated herein.

Thus, in various aspects of the disclosure, methods of providing hydrogen-containing streams having minimal or negligible concentrations of undesirable gaseous reactive nitrogen-containing compounds are provided herein. The methods of the present disclosure provide a method of controlled release of hydrogen from solid and/or liquid multi-phase materials to provide a controlled and effective hydrogen release from multi-phase hydrogen storage materials. The disclosure further provides optimization and maximization of the amount of hydrogen released, while retaining the nitrogen-containing compounds within the hydrogen storage material system to maintain the capability for long-term reversible cycling. In various aspects, the disclosure also provides hydrogen storage materials with high hydrogen storage release capacities, as well as good stability during storage, which is especially advantageous in fuel cell applications. The reaction to generate hydrogen is readily controlled by temperature and pressure, and the solid phase is capable of storing hydrogen for prolonged periods at moderate conditions.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A method of releasing hydrogen comprising:
combining a first composition comprising a nitride having one or more cations other than hydrogen, a second composition comprising a hydride having one or more cations other than hydrogen, and a third composition comprising a compound having a cation selected from the group consisting of: alkali metals, alkaline earth metals, and mixtures thereof, wherein a hydrogen-containing stream having a minimal concentration of gaseous reactive nitrogen-containing compounds is generated.

2. The method of claim 1, wherein the presence of said third composition reduces a concentration of any gaseous reactive nitrogen-containing products in the hydrogen-containing stream.

3. The method of claim 1, wherein said combining promotes a reaction to release hydrogen.

4. The method of claim 1, wherein said combining forms a stable hydrogen storage composition, and said generating occurs by releasing hydrogen from said stable hydrogen storage composition.

5. The method of claim 4, wherein said stable hydrogen storage composition comprises a compound having the general formula:
M′ₓM″_{y}N_{z}H_{d}
wherein
(a) M′ is a cation selected from the group consisting of: Li, Ca, Na, Mg, K, Be, and mixtures thereof and x is greater than about 50 and less than about 53;
(b) M″ comprises a cation composition comprising a Group 13 element of the Periodic Table and y is greater than about 5 and less than about 34;
(c) N is nitrogen and z is greater than about 16 and less than about 45;
(d) H is hydrogen and in a fully hydrogenated state, d is greater than about 110 and less than about 177; and
(d) wherein M′, M″, x, y, z, and d are selected so as to maintain electroneutrality.

6. The method of claim 1, wherein said combining promotes a hydrogen release reaction that forms one or more byproduct compounds comprising: nitrogen, at least one of said one or more cations other than hydrogen derived from said nitride composition and from said hydride composition, respectively, and said one or more byproduct compounds form at least two distinct non-gaseous phases.

7. The method of claim 1, wherein said first composition is represented by the general formula MIII^{′}(NH₈)_{g}^{-c}, said second composition is represented by the general formula MIₐ(MIIH_{b})_{c}, and said third composition is represented by MIIIHₕ, wherein MI and MII are selected from the group consisting of: CH₃, Al, As, B, Ba, Be, Ca, Cd, Ce, Cs, Cu, Eu, Fe, Ga, Gd, Ge, Hf, Hg, In, K, La, Li, Mg, Mn, Na, Nd, Ni, Pb, Pr, Rb, Sb, Sc, Se, Si, Sm, Sn, Sr, Th, Ti, TI, W, Y, Yb, Zn, Zr, and mixtures thereof, and MIII is selected from the group consisting of Li, Na, K, Rb, Be, Ca, Sr, and mixtures thereof, wherein h represents an atomic ratio of hydrogen in said third composition ranging from 0 to about 2, and a, b, c, e, f, g, and h are selected to maintain electroneutrality.

8. The method of claim 1, wherein said third composition comprises at least one cation selected from the group consisting of: Li, Na, K, Be, Mg, Ca, and mixtures thereof.

9. The method of claim 1, wherein said during said combining, said first composition is present in a molar amount of “a”, wherein I≦a≦4, said second composition is present in a molar amount of “b”, wherein 0.5≦b≦3, and said third composition is present in a molar amount of “c”, wherein 0<c≦5.

10. The method of claim 9, wherein “a” is about 2, wherein “b” is about 1, and wherein “c” is greater than zero and less than or equal to about 3.

11. The method of claim 1, wherein said third composition comprises a compound selected from the group consisting of: lithium hydride (LiH), sodium hydride (NaH), magnesium hydride (MgH₂), beryllium hydride (BeH₂), and mixtures thereof.

12. The method of claim 1, wherein said first composition comprises a compound selected from the group consisting of: lithium amide (LiNH₂), sodium amide (NaNH₂), magnesium amide (Mg(NH₂)₂), Li₃N (lithium nitride), magnesium imide (MgNH), borazane (BNH₆), lithium azide (LiN₃), and mixtures thereof, and said second composition comprises a compound selected from the group consisting of: lithium hydride (LiH), lithium aluminum hydride (LiAlH₄), sodium borohydride (NaBH₄), lithium borohydride (LiBH₄), magnesium borohydride Mg(BH₄)₂, sodium aluminum hydride (NaAlH₄), and mixtures thereof.

13. The method of claim 1, wherein said first composition comprises lithium amide (LiNH₂), said second composition comprises lithium borohydride (LiBH₄), and said third composition comprises lithium hydride (LiH).

14. The method of claim 1, wherein said hydrogen-containing stream has a concentration of gaseous reactive nitrogen-containing compounds of less than about 2 mole % of said stream.

15. A method of generating a hydrogen-containing gas stream, comprising:
providing a hydrogen storage system formed from hydrogenated starting materials comprising a first composition comprising a nitride having one or more cations other than hydrogen, a second composition comprising a hydride having one or more cations other than hydrogen, and a third composition comprising a compound having a cation selected from the group consisting of: alkali metals, alkaline earth metals, and mixtures thereof; and
generating hydrogen from said hydrogen storage system via a dehydrogenation reaction, wherein the hydrogen-containing gas stream comprises said hydrogen and is substantially free of reactive nitrogen-containing compounds.

16. The method of claim 15, wherein the presence of said third composition in said hydrogen storage system serves to reduce a concentration and/or to prevent formation of any gaseous nitrogen-containing compounds formed during said dehydrogenation reaction.

17. The method of claim 15, wherein said first composition comprises a compound selected from the group consisting of: lithium amide (LiNH₂), sodium amide (NaNH₂), magnesium amide (Mg(NH₂)₂), Li₃N (lithium nitride), magnesium imide (MgNH), borazane (BNH₈), lithium azide (LiN₃), and mixtures thereof; said second composition comprises a compound selected from the group consisting of: lithium hydride (LiH), lithium aluminum hydride (LiAIH₄), sodium borohydride (NaBH₄), lithium borohydride (LiBH₄), magnesium borohydride Mg(BH₄)₂, sodium aluminum hydride (NaAlH₄), and mixtures thereof; and said third composition comprises a compound selected from the group consisting of: lithium hydride (LiH), sodium hydride (NaH), magnesium hydride (MgH₂), beryllium hydride (BeH₂), and mixtures thereof.

18. The method of claim 15, wherein said first composition comprises lithium amide (LiNH₂), said second composition comprises lithium borohydride (LiBH₄), and said third composition comprises lithium hydride (LiH).

19. The method of claim 15, wherein said generating is conducted in an atmosphere comprising hydrogen nitrogen, helium, argon, and mixtures thereof.

20. A hydrogen storage system comprising:
(a) a hydrogenated state capable of releasing hydrogen and formed from starting materials comprising a first composition comprising a nitride having one or more cations other than hydrogen; a second composition comprising a hydride having one or more cations other than hydrogen; and a third composition comprising a compound having an alkali metal cation, an alkaline earth metal cation, and mixtures thereof; and
(b) a dehydrogenated state formed after release of hydrogen from said hydrogenated state comprising: one or more byproduct compositions comprising: nitrogen and at least one of said one or more cations other than hydrogen derived from said nitride and derived from said hydride, and said alkali earth metal cation, said alkaline earth metal cation, or mixtures thereof, respectively, wherein said one or more byproduct compositions are in a solid and/or liquid state.
